(19) United States
(12) Patent Application Publication
(10) Pub. No.: US 2006/0120498 A1
(43) Pub. Date: Jun. 8, 2006

(54) System, apparatus, and method to increase information transfer across clock domains

(76) Inventors: Swee-Hing Wong, Kepong (MY); Peter Gorman, County Clare (IE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/056,488

(22) Filed: Feb. 10, 2005

(30) Foreign Application Priority Data
Dec. 6, 2004 (MY) PI 20045039

(51) Int. Cl. H04L 7/02

(52) U.S. Cl. 375/359

(57) ABSTRACT

Method and apparatus for clock enabled information transfer are described.

### BACKGROUND

In a processor, computer, network, and/or communication system, information may be transferred between two disparate clock domains. For example, clock domains that operate at different clock frequencies relative to each other, or have clocks with variable phase and time relationships relative to each other. Control signals such as transmit and receive clock enable pulses may be used to facilitate a safe unidirectional or bidirectional transfer of information across the clock domain boundary. Conventional implementations of clock enabled information transfer schemes generate both transmit and receive enable clock pulses in only one of the clock domains and generally in the higher frequency or fast clock domain. Transmit and receive clock enable pulses originating from the fast clock domain may be used to rate-limit information transfers from the fast clock domain to a lower frequency or slow clock domain, and to minimize the risk of setup or hold violations, in either direction (e.g., transfers from fast to slow or slow to fast clock domains). This conventional implementation, however, limits the information transfer throughput. In other words, it limits the volume of information that can be processed or transferred from the fast clock domain to the slow clock domain or vice versa over a given period.

### BRIEF DESCRIPTION OF THE DRAWINGS

FIG. 1 illustrates a block diagram of a system 100.

FIG. 2 illustrates a block diagram of an element 200.

FIG. 3 illustrates a block diagram of a system 300.

FIG. 4 illustrates a block diagram of a system 400.

FIG. 5 illustrates a timing diagram 500.

FIG. 6 illustrates a timing diagram 600.

FIG. 7 illustrates a timing diagram 700.

FIG. 8 illustrates a programming logic 800.

### DETAILED DESCRIPTION

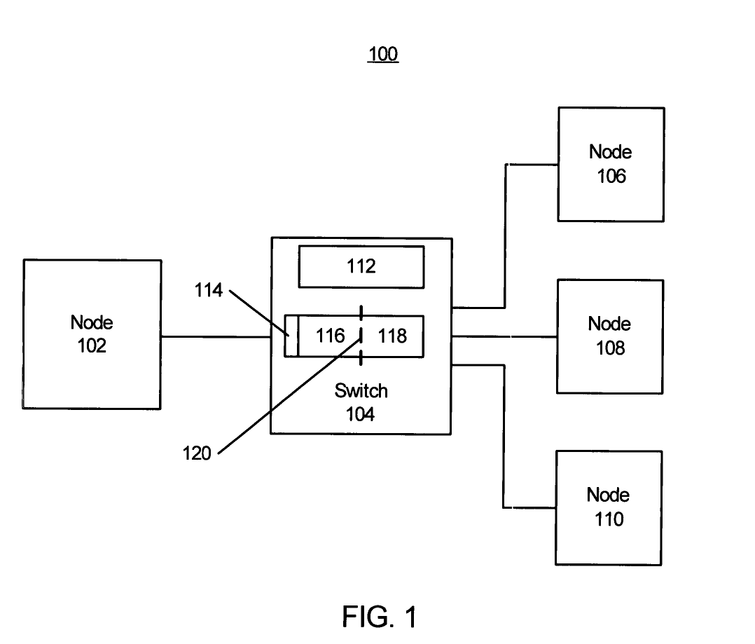

FIG. 1 illustrates a block diagram of a system 100. The system 100 may comprise, for example, a communication system having multiple nodes. A node may comprise any physical or logical entity having a unique address in the system 100. Examples of a node may include, but are not necessarily limited to, a computer, server, workstation, laptop, ultra-laptop, handheld computer, telephone, cellular telephone, personal digital assistant (PDA), router, switch, bridge, hub, gateway, wireless access point (WAP), and so forth. The unique address may comprise, for example, a network address such as an Internet Protocol (IP) address, a device address such as a Media Access Control (MAC) address, and so forth. The embodiments are not limited in this context.

The nodes of the system 100 may be arranged to communicate different types of information, such as media information and control information. Media information may refer to any information representing content meant for a user, such as voice information, video information, audio information, text information, alphanumeric symbols, graphics, images, and so forth. Control information may refer to any information representing commands, instructions or control words meant for an automated system. For example, control information may be used to route media information through a system, or instruct a node to process the media information in a predetermined manner.

The nodes of the system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth. For example, the system 100 may comprise a packet network communicating information in accordance with one or more packet protocols, such as one or more Internet protocols. In another example, the system 100 may communicate packets using a medium access control protocol such as Carrier-Sense Multiple Access with Collision Detection (CSMA/CD), as defined by one or more IEEE 802 Ethernet standards. The embodiments are not limited in this context.

The system 100 may be implemented as a wired communication system, a wireless communication system, or a combination of both. Although the system 100 may be illustrated using a particular communications media by way of example, it may be appreciated that the principles and techniques discussed herein may be implemented using any type of communication media and accompanying technology. The embodiments are not limited in this context.

When implemented as a wired system, the system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter also may include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, the system 100 may include one or more wireless nodes arranged to communicate information over one or more types of wireless communication media. An example of a wireless communication media may include portions of a wireless spectrum, such as the radio-frequency (RF) spectrum. The wireless nodes may include components and interfaces suitable for communicating information signals over the designated wireless spectrum, such as one or more antennas, wireless transmitters/receivers (“transceivers”), amplifiers, filters, control logic, and so forth. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, and so forth. The embodiments are not limited in this context.

Referring again to FIG. 1, the system 100 may comprise nodes 102, 106, 108 and 110. In addition, system 100 may include a switch or router 104 (collectively referred to herein as “switch 104”). Although FIG. 1 is shown with a limited number of elements in a certain topology, it may be appreciated that the system 100 may include more or less elements in any type of topology as desired for a given implementation. The embodiments, however, are not limited in this context.

In one embodiment, the system 100 may include the nodes 102, 106, 108 and 110. The nodes 102, 106, 108 and 110 may comprise, for example, computers. The nodes may communicate information to each other in the form of packets, for example. A packet in this context may refer to a set of information of a limited length, with the length typically represented in terms of bits or bytes. An example of a packet length might be 64 bytes. For example, node 102 may break a set of media information into a series of packets. Each packet may contain a portion of the media information plus some control information. The control information may assist various intermediate nodes to route each packet to its intended destination, such as one or more of nodes 106, 108 and 110. The destination node may receive the entire set of packets and use them to reproduce the media information from node 102.

In one embodiment, the system 100 may include the switch 104. The switch 104 may comprise a network switch or router operating in accordance with one or more media access control protocols, such as from the IEEE 802.3 series of Ethernet protocols. For example, the switch 104 may be a high bandwidth switch, such as a Fast Ethernet switch operating at 100 megabits per second (Mbps), a Gigabit Ethernet switch operating at 1000 Mbps, and so forth. The embodiments are not limited in this context.

The switch 104 may switch packets between the various nodes of the system 100. For example, the switch 104 may switch packets from a source node to a destination node. Each packet may include a source address and destination address. The switch 104 may receive the packet, retrieve the destination address, and send the packet to an intermediate node or destination node based on the destination address. The system 100 may operate to transfer information between node 102 and nodes 106, 108, 110 via the switch 104. The switch 104 may comprise one or more network processors 112 to communicate information (e.g., packets) between the switch 104 and any of one of the nodes 102, 106, 108, 110 for example.

In one embodiment, the switch 104 may include a clock domain boundary 120 where information may be transferred across multiple clock domains, such as, for example, first and second clock domains 116, 118. Information transfer between clock domains may be unidirectional or bidirectional depending on the particular implementation. The switch 104 also may include a controller 114 element to control unidirectional and bidirectional transfers of information between devices operating in the multiple clock domains. The operation of the controller 114 may comprise multiple elements, such as logic devices or code, for example. These elements may be implemented using, for example, one or more circuits, components, registers, processors, machine executable instructions, software subroutines, or any combination thereof. In one embodiment, the first and second clock domains 116, 118 each may include separate first and second clocks, respectively, operating at different frequencies, for example. In one embodiment, the multiple clocks associated with the multiple clock domains may be derived from a single phase-locked loop (PLL). In one embodiment, the multiple clocks derived from the single PLL may include edges that periodically align every N cycles (alignment period) of any one of the multiple clocks, for example. In one embodiment, the signal edges associated with the multiple clocks may align periodically every N cycles of the highest frequency (e.g., fastest) clock, for example. Although the controller 114 is illustrated as forming a portion or module of the switch 104, it may be appreciated that the controller 114 may be implemented anywhere in the system 100, including nodes 102, 106, 108, 110 and/or the network processor 112, for example. In addition, the controller 114 may form a portion of an integrated circuit device in any one of the nodes 102, 106, 108, 110 and/or the network processor 112. In one embodiment, the integrated circuit device may comprise a logic device, network processor, application specific integrated circuit (ASIC), microprocessor, network processor, switch, router, gateway, media gateway, modem, and the like, for example.

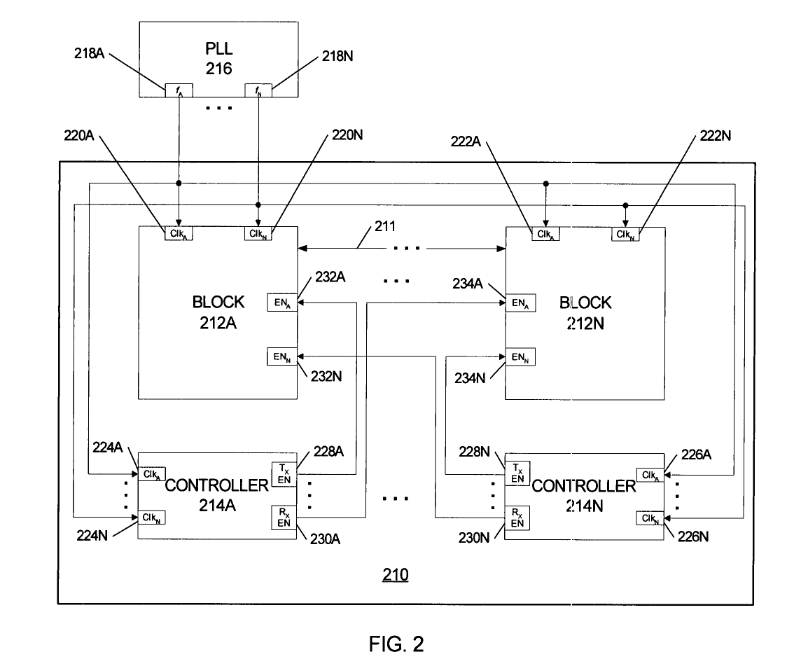

FIG. 2 illustrates a system 200 comprising a single integrated circuit 210 including a plurality of elements such as blocks 212A, N, controllers 214A, N, and a phase locked loop 216, where N may be any number of such elements. Those skilled in the art will appreciate that the integrated circuit 210 may comprise only a portion of the blocks 212A, N and the other one or more blocks 212A, N may be located off the integrated circuit 210, for example. Furthermore, those skilled in the art will appreciate that the integrated circuit 210 also may comprise the PLL 216, for example. In one embodiment the integrated circuit 210 may be any one of a logic device, network processor, application specific integrated circuit (ASIC), microprocessor, switch, router, gateway, media gateway, modem, and the like, for example.

One or more of the blocks 212A, N may operate in different clock domains. As used herein, clock domains may be defined as domains that operate at faster or slower clock frequencies relative to each other, or have clocks with variable phase and time relationships relative to each other. Information may be transferred in a unidirectional or bidirectional mode between any one of the blocks 212A, N along communication line 211. Although the communication line 211 is shown as a single line, in one embodiment the communication line 211 may represent a communication bus that interconnects any one of the blocks 212A, N to each other, for example. In one embodiment the controllers 214A, N may operate to increase the information transfer throughput between any one of the blocks 212A, N operating in different clock domains. Throughput, as used herein, is the amount of information that may be successfully transferred from one block to another in a given time period. As used herein, the blocks 212A, N may comprise intellectual property (IP) blocks and/or functional elements for various architectural platforms. The functional elements may be implemented using logic devices or code such as, for example, one or more circuits, components, registers, processors, machine executable instructions, software subroutines, or any combination thereof. The functions realized by the functional elements comprise, for example, communications, control, timing, digital signal processing (DSP), memory control, microprocessor/microcontroller core, networking, system peripheral, and wireless baseband functions, among others. More specifically, the functions may comprise, for example, wireless fidelity or networking (WiFi), digital subscriber line (DSL), gigabit Ethernet, security, peripheral component interconnect (PCI) bus, double data rate (DDR), universal asynchronous receiver-transmitter (UART), among others.

In one embodiment, the PLL 216 generates a plurality of clock frequencies f_{A}, f_{N} at outputs 218A, 218N. The clock frequencies f_{A}, f_{N} are fed to the clock inputs 220A, N of block 212A and the clock inputs 222A, N of block 212N. The clock frequencies f_{A}, f_{N} also are fed to the clock inputs 224A, N of controller 214A and the clock inputs 226A, N of controller 214N. Each of the controllers 214A, N may include at least one transmit enable output T_{X} 228A, N control signal, respectively, and at least one receive enable output R_{X} 230A, N control signal, respectively. The transmit enable output 228A is connected to the enable input EN_{A} 232A of block 212A and the receive enable output 230A is connected to the enable input EN_{A} 234A of block 212N. The transmit enable output 228N is connected to the enable input EN_{N} 234N of block 212N and the receive enable output 230N is connected to the enable input EN_{N} 232N of block 212A. As discussed previously, the controllers 214A, N may increase the information throughput across communication line 211 between blocks 212A, N operating in different clock domains. For example, in one embodiment, the controllers 214A, N increase the information throughput between the blocks 212A, N by controlling enable ports 224A, N of block 212A and enable ports 226A, N of block 212N.

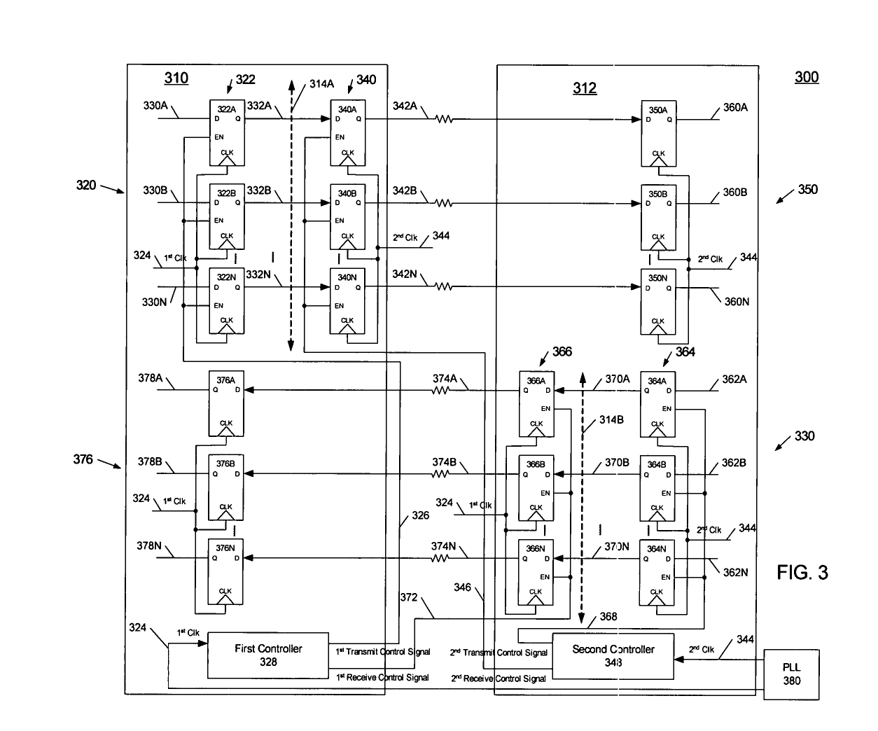

FIG. 3 illustrates one embodiment of a bidirectional data transfer system 300 for transferring information to and from a first and second clock domain across clock domain boundaries 314A, B, for example. The system 300 may comprise a first controller 328 and a second controller 348 to control the bi-directional transfer of information or samples between a first block 310 and a second block 312 across clock domain boundaries 314A, B. The operation of the first and second controllers 328, 348 may comprise multiple elements, such as logic devices or code, for example. These elements may be implemented using, for example, one or more circuits, components, registers, processors, machine executable instructions, software subroutines, or any combination thereof. Although FIG. 3 may show a limited number of such elements, it will be appreciated that additional or fewer elements may be used as desired for a given implementation. The embodiments, however, are not limited in this context.

Each block 310, 312 receives a first clock signal 324 (e.g., a slow clock frequency of 200 MHz) and a second clock signal 344 (e.g., a fast clock frequency of 225 MHz), generated by a single PLL 380, for example. In one embodiment, the clock domain boundary 314A separates devices in the first block 310 operating at different clock frequencies such as the first and second clocks 324, 344 and the clock domain boundary 314B separates devices in the second block 312 operating at different clock frequencies such as the first and second clocks 324, 344.

The first block 310 comprises a first logic portion 320 comprising a plurality of enabled logic devices 322, 340. The first logic portion 320 transfers information from the first block 310 to the second block 312 across the clock domain boundary 314A. Each of the logic devices 322, 340 may comprise a sample input “D,” a sample output “Q,” a clock input “CLK,” and an enable input “EN,” for example. The logic devices 340 are driven by the second clock 344 and are enabled by a second receive enable signal 346 generated by the second controller 348, for example. The logic devices 322 are driven by the first clock 324 and are enabled by a first transmit enable control signal 326 generated by the first controller 328, for example.

The logic devices 322A-N receive information to be transferred on lines 330A-N of logic devices 322A-N, respectively, where N may be the width in bits of an information bus comprising the lines 330A-N, for example. The logic devices 322A-N receive information in the first block 310 at a rate established by the first clock 324 frequency and transmits the information across the clock domain boundary 314A to the logic devices 340A-N at a rate established by the second clock 344 frequency. The logic devices 322A-N are driven by the first clock 324 and are controlled by the first transmit control signal 326 generated by the first controller 328. Accordingly, information or samples on lines 330A-N are transferred to the corresponding outputs 332A-N on the transitions of the first clock 324 when the first transmit control signal 326 is applied to the enable inputs “EN” of the logic devices 322A-N. The outputs 332A-N of the logic devices 322A-N are connected to the inputs of logic devices 340A-N, respectively. Information is transferred to the outputs 342A-N on the transitions of the second clock 344 when the second receive control signal 346 is applied to the enable inputs “EN” of the logic devices 340A-N. Accordingly, the information is transferred across the clock domain boundary 314A in the first block 310 and is provided to the inputs of logic devices 350A-N in the second block 312. The logic devices 350A-N may neither include nor require an enable input. Information appearing at their sample inputs is simply transferred to the corresponding outputs 360A, N on the transitions of the second clock 344 alone.

The system 300 further comprises a second logic portion 330 comprising a plurality of enabled logic devices 364, 366. The second logic portion 330 transfers information from the second block 312 to the first block 310 across the clock domain boundary 314B. Each of the logic devices 364, 366 may comprise a sample input “D,” a sample output “Q,” a clock input “CLK,” and an enable input “EN,” for example. The logic devices 364 are driven by the second clock 344 and are enabled by a second transmit control signal 368 generated by the second controller 348, for example. The logic devices 366 are driven by the first clock 324 and are enabled by the first receive control signal 372, generated by the first controller 328, for example.

The logic devices 364A-N receive information to be transferred on lines 362A-N, respectively, where N may be the width in bits of the information bus comprising lines 362A-N, for example. The logic devices 364A-N receive information in the second block 312 at a rate established by the second clock 344 frequency and transmits the information across the clock domain 314B to the logic devices 366A-N at a rate established by the first clock 324 frequency. The logic devices 364A, N are driven by the second clock 344 and are controlled by the second transmit control signal 368 generated by the second controller 348. Accordingly, information or samples on lines 362A-N are transferred to the corresponding outputs 370A-N on the transition of the second clock 344 when the second transmit control signal 368 is applied to the enable inputs “EN” of the logic devices 364A-N. The outputs 370A-N of the logic devices 364A-N are connected to the inputs of logic devices 366A-N, respectively. Information is transferred to the outputs 374A-N on the transition the first clock 324 when the first receive control signal 372 is applied at the enable inputs “EN” of the logic devices 366A-N. Thus, the information is transferred across the clock domain boundary 314B in the second block 312 and is provided to logic devices 376A-N in the first block 310. The logic devices 376 may neither include nor require an enable input and information appearing at its sample inputs is simply clocked to its corresponding outputs 378A-N on the transitions of the first clock 324 alone.

The first controller 328 is driven by the first clock signal 324 and outputs the first receive control signal 372 to control the enable inputs EN of logic devices 366 in the second block 312. These logic devices 366 also are driven by the first clock signal 324 at their CLK inputs. The first controller 328 also outputs a first transmit control signal 326 to control the enable inputs EN of logic devices 322 located in the first block 310. These logic devices 322 also receive the first clock signal 324 at their CLK inputs.

The second controller 348 is driven by the second clock signal 344 and outputs the second receive control signal 346 to control the enable inputs EN of logic devices 340 located in the first block 310. These logic devices 340 also are driven by the second clock signal 344 at their CLK inputs. The second controller 348 also outputs a second transmit control signal 368 that is connected to the enable inputs EN of logic devices 364 located in the second block 312. These logic devices 364 also are driven by the second clock signal 344 at their CLK inputs.

Under the control of the first and second controllers 328, 348, information may be transferred from logic devices 322 to logic devices 340 across the clock domain boundary 314A. Likewise, under the control of the first and second controllers 328, 348, information may be transferred from logic devices 364 to logic devices 366 across the clock domain boundary 314B. Those skilled in the art will appreciate, however, that this is one of many implementations to avoid maximum delay and setup uncertainty. Thus, the cross clock domains 314A, B may be located within the individual first and second blocks 310, 312, respectively, for example. The embodiments, however, are limited in this context.

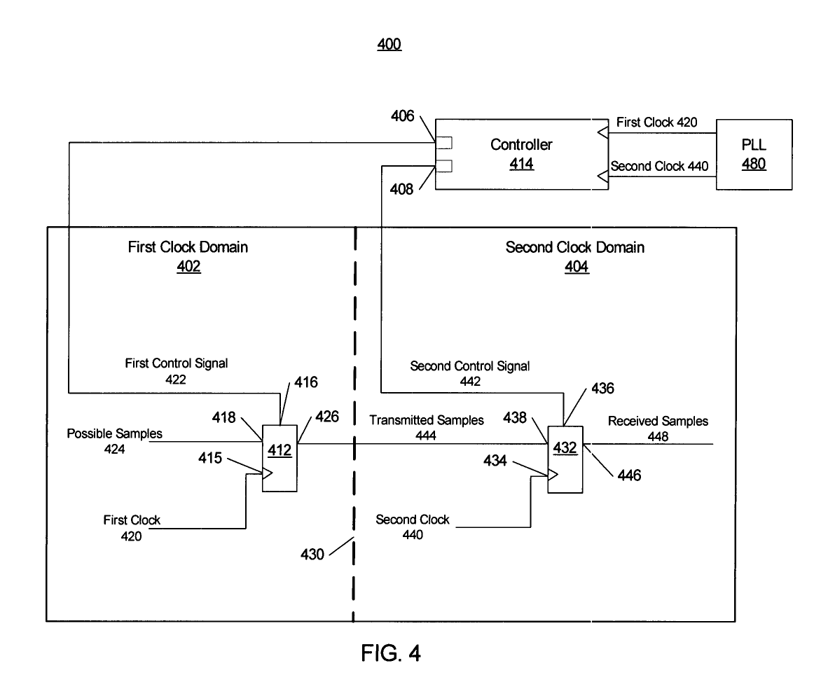

FIG. 4 is a block diagram of a unidirectional information transfer system 400 for transferring information from a first clock domain 402 to a second clock domain 404 across a clock domain boundary 430. In one embodiment, the system may include a controller 414, for example, to generate a first clock domain 402 transmit control signal at output 406, referred to hereinafter as a first transmit control signal 422, and a second clock domain 404 receive control signal at output 408, referred to hereinafter as a second receive control signal 442. In one embodiment, the controller 414 may control the operation of first and second logic devices 412, 432 located in the first and second clock domains 402, 404, respectively. In one embodiment, the first and second logic devices 412, 432 may comprise any device, circuit or code. In operation the first and second logic devices 412, 432 may assume either of two stable states or may store at least one bit of information, for example. In one embodiment, the first and second logic devices 412, 432 may each comprise a flip-flop, for example. In one embodiment, the controller 414 may comprise multiple elements, such as logic devices or code, for example. These elements may be implemented using, for example, one or more circuits, components, registers, processors, machine executable instructions, software subroutines, or any combination thereof. Although FIG. 4 may show a limited number of such elements, it will be appreciated that additional or fewer elements may be used as desired for a given implementation. The embodiments, however, are not limited in this context.

In one embodiment, the controller 414 controls the unidirectional transfer of information between the first clock domain 402 and the second clock domain 404 across the clock domain boundary 430, for example. In one embodiment, the controller 414 receives a first clock signal 420 having a first frequency and a second clock signal 440 having a second frequency, for example. In one embodiment, the first frequency may be higher than the second frequency. As such, the first clock may be referred to as a “fast” clock and the second clock may be referred to as a “slow” clock, for example. Thus, the first clock domain 402 may be referred to the “fast” clock domain and the second clock domain 404 may be referred to as the “slow” clock domain. Those skilled in the art will appreciate that the system 400 illustrates one of many embodiments of systems for transferring samples from the first clock domain 402 to the second clock domain 404 using the first transmit control signal 422 and the second receive control signal 442 in conjunction to control the transfer of possible samples 424 from the “fast” clock domain 402 to the “slow” clock domain 404. The first transmit control signal 422 enables the transmission of possible samples 424 from the first clock domain 402 to the second clock domain 404. The second receive control signal 442 enables the transmission of the transmitted samples 444 at input 438 of the second logic device 432 in the second clock domain 404. The output 446 of the second logic device 432 provides the captured or received samples 448,

The controller 414 may facilitate a safer transfer of possible samples 424 between the two clock domains 402, 404. The possible samples 424 may be transferred one bit at a time over a communication link between the source node and destination node(s) across the clock domain 430, for example. To facilitate a safe transfer of the possible samples 424 the controller 414 may perform many functions such as limiting the rate at which the possible samples 424 are transferred to reduce the risk of setup and hold violations during the transfer. In one embodiment, for example, when the first clock domain 402 operates at a higher clock frequency (“fast clock”) than the second clock domain 404, the controller 414 may limit the rate at which the possible sample 4242 are transferred from the first clock domain 402 to the second clock domain 404. Rate limiting the information transfer may help ensure that the information is not lost by the devices in the slower clock domain. The controller 414 also may minimize risk associated with setup and hold violations when information is transferred between the first clock domain 402 and the second clock domain 404.

In one embodiment, the first and second logic devices 412, 432 are operated or synchronized by the first and second clocks 420, 440, respectively. The first and second clocks 420, 440 are generated by a single PLL 480 and provide timing references for a transmission link between the first and second clock domains 402, 404, for example. In one embodiment, the first clock 420 may comprise a sequence of pulses at a frequency of 90 MHz (“fast clock”), for example, and the second clock 440 may comprise a sequence of pulses at a frequency of 30 MHz (“slow clock”), for example. In another embodiment, the first clock 420 may comprise a sequence of pulses at a frequency of 225 MHz (“fast clock”), for example, and the second clock 440 may comprise a sequence of pulses at a frequency of 200 MHz (“slow clock”), for example. In this context, the terms “fast clock” and “slow clock” are used to indicate the relative difference in the clock frequencies. The terms “fast clock” and “slow clock” are merely used herein to indicate that the first and second clock domains 402, 404 operate at faster or slower clock frequencies relative to each other, or have clocks with variable phase and time relationships relative to each other. The terms “fast clock” and “slow clock,” however, are not to be construed in an absolute sense. The embodiments are not limited to the particular clock frequencies (e.g., fast clock and slow clock) described herein or to the relative differences or ratios of these clock frequencies or phases.

The first logic device 412 may include a clock input 414, an enable input 416, a sample input 418, and a sample output 426, for example. The term sample may refer to single or multiple discrete bits of information to be transferred from the first clock domain 402 to the second clock domain 404, for example. The clock input 415 may receive the first clock signal 420, for example. The controller 414 may provide the first transmit control signal 422 (e.g., a fast to slow transmit enable control signal) to the enable input 416 of the first logic device 412. A possible sample 424 of information at the sample input 418 may be transferred to the sample output 426 at a subsequent transition or state change of the first clock signal 420 while the first transmit control signal 422 enables the first logic device 412, for example.

The second logic device 432 also may include a clock input 434, an enable input 436, a sample input 438, and a sample output 446, for example. The sample of information transferred from the first clock domain 402 may be referred to as a transmitted sample 444, for example. The clock input 434 may receive the second clock signal 440, for example. The controller 414 may provide the second receive control signal 442 (e.g., fast to slow receive enable control signal) to the enable input 436 of the second logic device 432. Applying the second receive control signal 442 to the receive enable input 436 allows the second logic device 432 to receive the transmitted sample 444 and transfer it from the sample input 438 to the sample output 446 at a subsequent transition or state change of the second clock signal 440, for example. Accordingly, in one embodiment, the transmitted samples 444 may be transferred from the sample input 438 to the sample output 446 and are output therefrom as received samples 448. A transmitted sample 444 may be transferred to the output 446 at a subsequent transition or state change of the second clock signal 440 while the second receive control signal 442 enables the second logic device 432, for example.

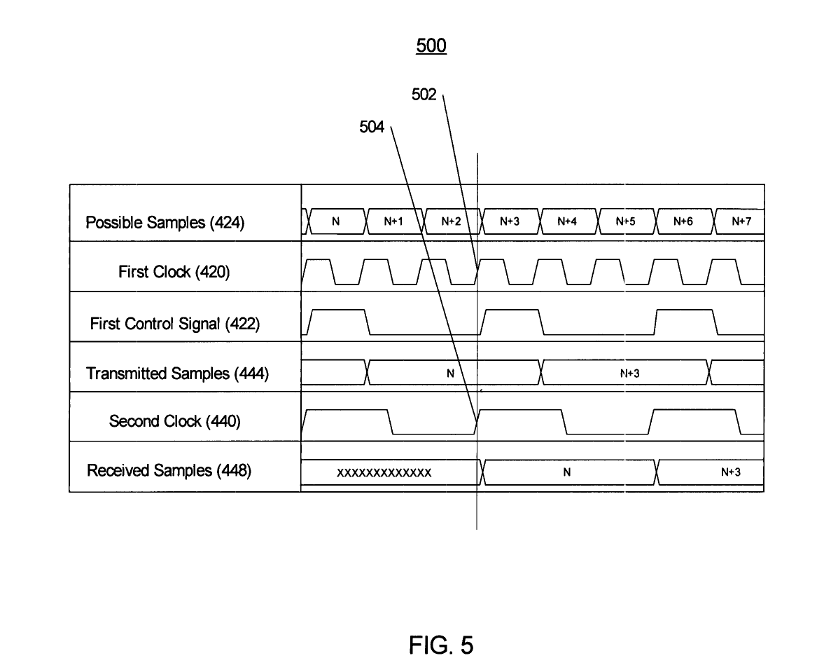

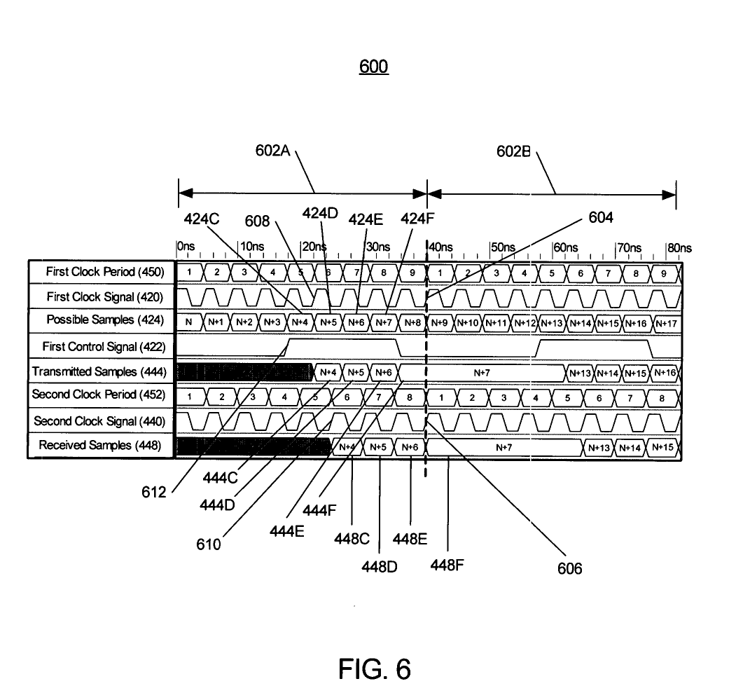

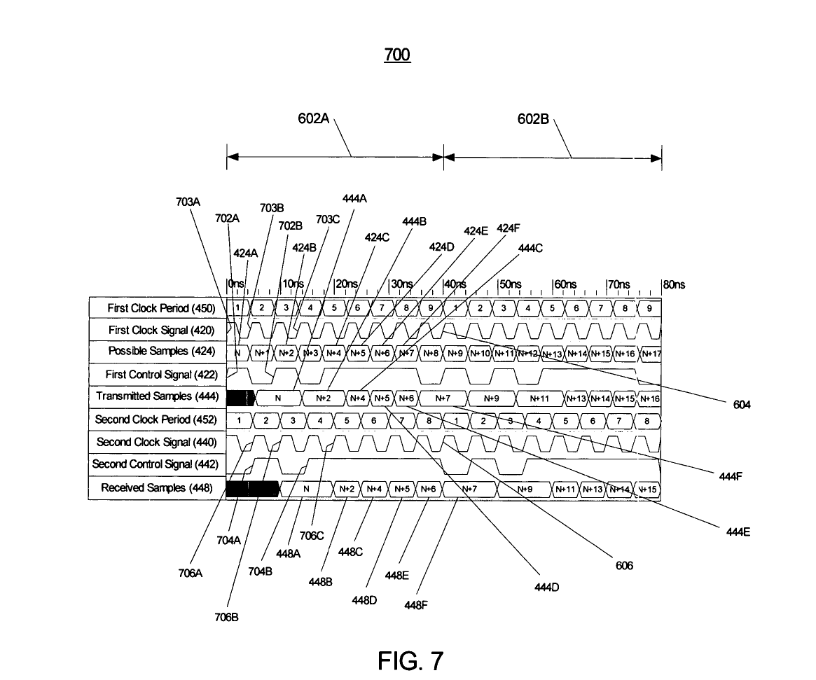

The operation of the various embodiments of the controllers 114, 328, 348, and 414 described above is analogous. Therefore, for clarity purposes and to avoid redundancy, various embodiments of the operation and function of these controllers 114, 328, 348, and 414 is described below with respect to the controller 414 illustrated in FIG. 4 and its associated timing diagrams 500 (see FIG. 5), 600 (see FIG. 6), and 700 (see FIG. 7). It will be appreciated, however, that the functionality of the controllers 114, 328, and 348 with respect to the timing diagrams may be readily understood and adapted based on the description of the operation of the controller 414 and the timing diagrams 500, 600, and 700.

FIG. 5 illustrates one embodiment of a timing diagram 500 associated with the operation of the controller 414 and the system 400 described in FIG. 4. Accordingly, in one embodiment, the controller 414 may facilitate and increase the information transfer rate (e.g., throughput) from the first clock domain 402 to the second clock domain 404 in accordance with the various waveforms illustrated in timing diagram 500.

In one embodiment, the controller 414 may facilitate the transfer of information from the first clock domain 402 driven by the first clock 420 to the second clock domain 402 driven by the second clock 440. As previously described, the first and second clocks 420, 440 may be considered different clock domains if they have variable phase and time relationships therebetween including, for example, if the first and second clock frequencies are different.

In one embodiment, the first clock 420 may operate at a frequency of 90 MHz (“fast clock” domain) and the second clock 440 may operate at a frequency of 30 MHz (“slow clock” domain), for example. These clocks 420, 440 provide a 3:1 clock frequency ratio between the first and second clock domains 402, 404. Thus, a rising edge 502 of the first clock 420 (90 MHz clock) in the first clock domain 402 may align with a rising edge 504 of the second clock 440 (30 MHz clock) in the second clock domain 404 every third rising edge of the first clock 420, for example.

In one embodiment, the controller 414 generates the first transmit control signal 422, which is synchronous with the first clock 420 in the first clock domain 402. Based on the 3:1 ratio of the clocks 420, 440, the first transmit control signal 422 may be asserted once every three 90 MHz clock periods and de-asserted for the other two 90 MHz clock periods, for example. Accordingly, there may be three possible points in time in which the first transmit control signal 422 may be asserted with respect to the second clock 440 to provide a safe transfer of the possible samples 424 from the first clock domain 402 to the second clock domain 404. Thus, for safe transfer of the possible samples 424, there are three possible positions for asserting the first transmit control signal 422 with respect to the second clock 440, slower clock. The first transmit control signal 422 may be asserted during a first, second or last third of the second clock 440 (30 MHz) period, for example.

The first transmit control signal 422 performs at least two basic functions: (1) it provides rate-limiting of the possible samples 424 to be transmitted; and (2) it minimizes the risk of setup violations, hold violations or both. In one embodiment, rate-limiting the possible samples 424 may be achieved by selecting any one of the three possible positions for the first transmit control signal 422 pulse as previously described. For example, if the samples 424 are sourced from a first-in-first-out buffer (FIFO), there is no advantage in providing new samples 424 every first clock 420 (90 MHz) edge because the second clock 440 (30 MHz) may miss two out of every three transmitted samples 444. Thus, in one embodiment, the first transmit control signal 422 may be used to limit the transfer rate of the possible samples 424 from the first clock domain 402 to one new possible sample 424 every three rising edges of the first clock 420 (90 MHz), for example. Based on the 3:1 clock ratio described in this one embodiment, the second clock domain 404 is capable of managing this particular transfer rate, for example.

Aligning a pulse of the first transmit control signal 422 with a first, second or last third portion of the second clock 440 period (30 MHz) may minimize the risk of setup or hold violations. Aligning the first transmit control signal 422 assertion with the first-third of the second clock 440 period and transmitting new possible samples 424 at the beginning of the second-third of the second clock 440 period, reduces the risk of violating both setup and hold time requirements. This, however, may depend on the first and second clock 420, 440 frequencies, the physical implementation of the clock domain boundary 430, and whether setup or hold is more difficult to meet in a particular embodiment. For example, transmitting a possible sample 424 during a first clock 420 period may allow more setup time and less hold time. Transmitting a possible sample 424 during a second first clock 420 period provides two first clock 420 periods for setup time and one first clock 420 period for hold time. Likewise, transmitting a possible sample 424 during a third first clock 420 period allows one first clock 420 period for setup time and two first clock 420 periods for hold.

The system 400 shown in FIG. 4 and the timing diagram 500 associated therewith illustrates a one way transfer of the possible samples 424 from the first clock domain 402 to the second clock domain 404. Those skilled art will appreciate, however, that samples may be transferred in the reverse direction, e.g., from the second clock domain 404 to the first clock domain 402 as illustrated and described previously with respect to system 300 (FIG. 3).

FIG. 6 illustrates a timing diagram 600 associated with the operation of the controller 414 for transferring possible samples 424 from the first clock domain 402 to the second clock domain 404 across the clock domain boundary 430 using only the first control signal 424 and without using the second receive control signal 442. The timing diagram 600 illustrates the relative positions in time of the first clock periods 450, the first clock signal 420, the possible samples 424 available for transfer, the first transmit control signal 422 (e.g., the fast clock domain to slow clock domain transmit enable signal), the transmitted samples 444, the second clock signal 440, and the received samples 448.

The description now follows with reference to the system 400 in FIG. 4 (except for the use of the second receive control signal 442) and the timing diagram 600 in FIG. 6. Accordingly, the possible samples 424 transmitted from the first clock domain 402 are received in the second clock domain 404 as transmitted samples 444 and are finally output from the second clock domain 404 as received samples 448. For illustrative purposes, the timing diagram in FIG. 6 shows the particular case where the possible samples 424 are transferred from the first clock domain 420 to the second clock domain 404 using only the first transmit control signal 422 without using the second receive control signal 442. As previously described, the first control signal 424 may be generated in the first clock domain 402. In the timing diagram 600, the first clock 420 frequency is 225 MHz and the second clock 440 frequency is 200 MHz. The ratio of first clock 420 frequency to the second clock 440 frequency is 9:8. Therefore, during a first alignment period 602A, a fast clock rising edge 604 and a slow clock rising edge 606 come into alignment every ninth first clock periods 450, which is every eighth second clock periods 452, for example.

In this example, it is assumed that a set-up time greater than a 2 ns difference between the rising edges of first and second clock 450, 452 is required for a safe transfer of the possible samples 424 from the first clock domain 402 to the second clock domain 404. Assuming a timing path between the first and second domains 402, 404 of a minimum of one-half of the first clock period 452 (≈2 ns) allows the possible samples 424 to be transferred without any set-up violations. This is true for each consecutive alignment period 602B, and so on, equal to nine first periods 452. In accordance with the 9:8 clock ratio, during each alignment period 602A, B, the timing path for safe transfer of the possible samples 424 is greater than one-half the first clock period 450 (≈2 ns) beginning with rising edge 608 of the sixth first clock period 450 relative to rising edge 610 of the sixth slow clock period 452. This condition remains true for four consecutive first clock periods 450 (e.g., periods 6, 7, 8, and 9).

Therefore, to ensure that the timing path between the first and second domains 402, 404 is at least a minimum of one-half the first clock period 450, the possible samples 424 may be safely transferred only during the last four first clock periods 450 (e.g., periods 6, 7, 8, and 9). Thus, the possible samples 424C, D, E, and F(N+4, N+5, N+6 and N+7) may be safely transferred. However the first five first clock periods 450 may not be safe to transfer because the timing path between the first and second clock periods 450, 452 is less than the minimum required one-half cycle of the first clock period 450. Accordingly, during the first five first clock periods 450 the first transmit control signal 422 is held low to prevent the transfer of any samples. The first transmit control signal 422 is pulled to a logic high at the start of the fifth first clock period 450 as indicated by rising edge 612. With the first transmit control signal 422 in a high state, the N+4 possible sample 424C is transmitted to the output of the first logic device 412 synchronous with the rising edge 608 of the sixth first clock period 450. The N+5, N+6, and N+7 possible samples 424D, 424E, and 424F are transmitted during the subsequent seventh, eight, and ninth first clock periods 450. The N+4 transmitted sample 444C appears at the output 426 of the first logic device 412 (e.g., the input 438 of the second logic device 432) during the sixth first clock period 450. Likewise, the N+5, N+6, and N+7 transmitted samples 444D, E, and F appear at the output 426 of the first logic device 412 and the input 438 of the second logic device 432 during the subsequent seventh, eighth, and ninth first clock periods 450 as long as the first transmit control signal 422 remains high and enables the first logic device 412 to transmit. The second clock 440 then captures the N+4, N+5, and N+6 transmitted samples 444C, D, and E during the sixth, seventh, and eighth second clock period 452 in the first alignment period 602A and captures the N+7 transmitted sample 444F during the first second clock period 452 of the second alignment period 602B. In a unidirectional data transfer example when the data is transferred from the first clock domain 402 to the second clock domain 404 and the first clock domain 402 frequency is relatively faster than second clock domain 404 frequency, only the first transmit control signal 422 is used to effect the data transfer. In this example, it is assumed that the receiving logic device 432, running at the second clock domain 404 frequency, is using sequential elements such as, for example, D flip-flops, without enable control. Hence the flip-flop or sequential logic device will register every clock cycle. The received samples 448C, D, E, and F are received at output 446 on each transition of the second clock 440 because in this example the second receive control signal 442 is not used to control the receipt of the transmitted samples 444. Thus, the throughput rate is approximately 44% because four possible samples 424C, D, E, and F are transmitted out of every nine possible samples during the first alignment period 602A. The other possible samples 424 in the alignment period 602A cannot be safely transmitted during the other first clock periods 450 because the rising edges of the first clock 420 become too close to the next rising edge of the second clock 440 (e.g., less than one-half of the second clock period 452).

FIG. 7 illustrates a timing diagram 700 associated with the operation of the controller 414, shown in FIG. 4, for transferring possible samples 424 from the first clock domain 402 to the second clock domain 404 across the clock domain boundary 430 using both the first transmit control signal 422 and the second receive control signal 442. The timing diagram 700 illustrates the transfer of the possible samples 424 from the first clock domain 402 to the second clock domain 404 using the first transmit control signal 422 generated by the first clock 420, for example, and the second receive control signal 442, generated by the second clock 440, for example, in controller 414. Using the first control signal 424 generated in the first clock domain 402 (“fast clock”) in conjunction with the second receive control signal 442 generated in the second clock domain 404 (“slow clock”) provides an increase in the transfer throughput of the possible samples 424 from the first clock domain 402 to the second clock domain 404.

As described previously with reference to FIG. 6, the first clock 420 frequency is 225 MHz and the second clock 440 frequency is 200 MHz. for a first clock 420 to second clock 440 frequency ration of 9:8. As discussed previously, with a clock ratio of 9:8, the rising edge 604 of the first clock 420 and the rising edge 606 of the second clock 440 align with each other every nine first clock period 450 and every eight second clock periods 452 during the alignment periods 602A, B. In the example described in FIG. 6, the possible samples 424 could be safely transferred only during the last four periods of the first clock 420 in each alignment period 602A, B because during that period the timing path between the two clock domains 402, 404 was at least one-half of one second clock period 452, for example.

In one embodiment, two additional edges 702A, B of the first transmit control signal 422 are asserted every second transmit edge 703A, B of the first clock 420, for example. As illustrated in FIG. 7, these additional edges 702A, B are asserted during the first four first clock periods 450 in the first alignment period 602. In addition, two selective second receive control signal 442 receive enable edges 704A, B are asserted every second receive edge 706A, B of the second clock 440. These edges 704A, B, however, are delayed by one first clock period 450 from the first edge 702A of the first transmit control signal 422.

Asserting the selective second receive control signal 442 receive enable at edges 704A, B in conjunction with the assertion of the additional two first transmit control signal 422 edges 702A, B creates two further safe launch periods in the first alignment period 602 in which to transmit possible samples 424. Therefore, the N and N+2 transmitted samples 444A, B are transmitted in addition to the N+4, N+5, N+6, and N+7 transmitted samples 444C, D, E, F. Thus, with the introduction of the second receive control signal 442 in the transmission scheme, the total number of received samples 448A, B, C, D, E (N, N+2, N+4, N+5, N+6, and N+7) is six out of nine possible samples 424 during each consecutive alignment periods 602A, B, and so on. Consequently, the sample throughput may be increased from four out of nine possible samples 424 (44%) to six out of nine possible samples 424 (66%) during consecutive alignment periods 602A, B. Thus, the throughput may be increased by 50% by combining the first transmit control signal 422 and the second receive control signal 442 in the transmission scheme.

Why the two additional transfers meet the setup requirement of one-half cycle of first clock's 420 period may be further illustrated as follows. In the two additional transfers, the second rising edge 703B of the first clock 420 is used to transmit the possible sample 424A (N) to the output 426 of the first logic device 412 as transmitted sample 444A (N), and the transmitted sample 444A (N) will be received a the input 438 of the second logic device 432 when triggered by the third rising edge 706B of the second clock 440. Because the time window between second rising edge 703B of the first clock 420 and the third rising edge 706B of the second clock 440 is greater than one-half a cycle of first clock's 420 period, the proper setup requirement is met and there is not setup violation. Similarly, the setup requirement is met when transferring the possible sample 424B (N+2) from first clock domain 402 to second clock domain 404 when the fourth rising edge 703C of the first clock 420 is used to launch the possible sample 424B (N+2) and the fifth rising edge 706C of the second clock 440 is used to capture the transmitted sample 444C (N+2). Again the time window between the fourth rising edge 703C of the first clock 420 and the fifth rising edge 706C of the second clock 440 is greater than one-half cycle of the first clock's 420 period and, therefore, there is no setup violation.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

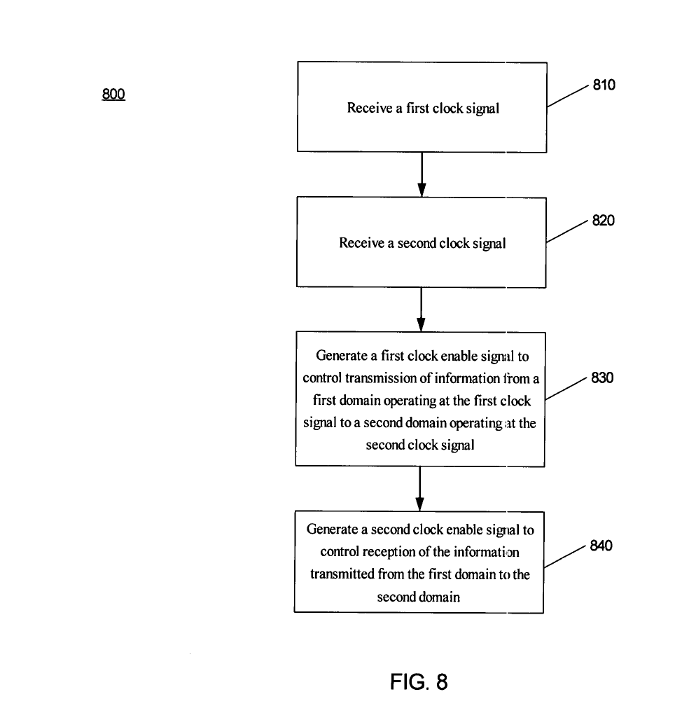

FIG. 8 illustrates a programming logic 800. Programming logic 800 may be representative of the operations executed by one or more systems described herein, such as system 100, 200, 300, 400 and/or control elements 114, 328, 348, and 414, for example. As shown in programming logic 800, at block 810, the system receives a first clock signal. At block 820, the system receives a second clock signal.

At block 830, the system generates a first clock enable signal to control transmission of information from a first domain operating at the first clock signal to a second domain operating at the second clock signal. The system may provide the first clock enable signal the first clock signal to a first logic device.

At block 840, the system generates a second clock enable signal to control reception of the information transmitted from the first domain to the second domain. The system may provide the second enable input and the second clock signal to a second logic device.

The system also may generate a third clock enable signal to control transmission of information from the second domain to the first domain. The system may generate a fourth clock enable signal to control reception of the information transmitted from the second domain to the first domain. The system may provide the third clock enable signal and the second clock signal to a third logic device. The system also may provide the fourth clock enable signal and the first clock signal to a fourth logic device.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input information rates, output information rates, memory resources, information bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms information represented as physical quantities (e.g., electronic) within the computing system's registers and/or memories into other information similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a first input to receive a first clock signal;
a second input to receive a second clock signal;
a first output to generate a first clock enable signal to control transmission of information from a first domain operating at the first clock signal to a second domain operating at the second clock signal; and
a second output to generate a second clock enable signal to control reception of the information transmitted from the first domain to the second domain.

2. The apparatus of claim 1, wherein the first clock signal is a higher frequency than the second clock signal.

3. The apparatus of claim 1, wherein the second clock signal is a lower frequency than the second clock signal.

4. The apparatus of claim 1, further comprising:
a first logic device including:
a first enable input connected to the first output to receive the first clock enable signal; and
a first clock input to receive the first clock signal.

5. The apparatus of claim 4, further comprising:
a second logic device including:
a second enable input connected to the second output to receive the second clock enable signal; and
a second clock input to receive the second clock signal.

6. The apparatus of claim 5, wherein the first logic device is connected to the second logic device.

7. The apparatus of claim 1, further comprising:
a third output to generate a third clock enable signal to control transmission of information from the second domain to the first domain; and
a fourth output to generate a fourth clock enable signal to control reception of the information transmitted from the second domain to the first domain.

8. The apparatus of claim 7, further comprising:
a third logic device including:
a third enable input connected to the third output to receive the third clock enable signal; and
a third clock input to receive the second clock signal.

9. The apparatus of claim 8, further comprising:
a fourth logic device including:
a fourth enable input connected to the fourth output to receive the fourth clock enable signal; and
a fourth clock input to receive the first clock signal.

10. The apparatus of claim 9, wherein the third logic device is connected to the fourth logic device.

11. A system, comprising:
a communication medium;
a network interface connected to the communication medium; and
a controller connected to the interface, the controller to include:
a first input to receive a first clock signal;
a second input to receive a second clock signal;
a first output to generate a first clock enable signal to control transmission of information from a first domain operating at the first clock signal to a second domain operating at the second clock signal; and
a second output to generate a second clock enable signal to control reception of the information transmitted from the first domain to the second domain.

12. The system of claim 11, wherein the first clock signal is a higher frequency than the second clock signal.

13. The system of claim 11, wherein the second clock signal is a lower frequency than the second clock signal.

14. The system of claim 11, wherein the controller further comprises:
a first logic device including:
a first enable input connected to the first output to receive the first clock enable signal; and
a first clock input to receive the first clock signal.

15. The system of claim 14, wherein the controller further comprises:
a second logic device including:
a second enable input connected to the second output to receive the second clock enable signal; and
a second clock input to receive the second clock signal.

16. The system of claim 15, wherein the controller further comprises the first logic device connected to the second logic device.

17. The system of claim 11, further wherein the controller further comprises:
a third output to generate a third clock enable signal to control transmission of information from the second domain to the first domain; and
a fourth output to generate a fourth clock enable signal to control reception of the information transmitted from the second domain to the first domain.

18. The system of claim 17, wherein the controller further comprises:
a third logic device including:
a third enable input connected to the third output to receive the third clock enable signal; and
a third clock input to receive the second clock signal.

19. The system of claim 18, wherein the controller further comprises:
a fourth logic device including:
a fourth enable input connected to the fourth output to receive the fourth clock enable signal; and
a fourth clock input to receive the first clock signal.

20. The system of claim 19, wherein controller further comprises the third logic device connected to the fourth logic device.

21. A method, comprising:
receiving a first clock signal;
receiving a second clock signal;
generating a first clock enable signal to control transmission of information from a first domain operating at the first clock signal to a second domain operating at the second clock signal; and
generating a second clock enable signal to control reception of the information transmitted from the first domain to the second domain.

22. The method of claim 21, further comprising:
providing the first clock enable signal to a first logic device; and
providing the first clock signal to the first logic device.

23. The method of claim 22, further comprising:
providing the second enable input the a second logic device; and
providing the second clock signal to the second logic device.

24. The method of claim 21, further comprising:
generating a third clock enable signal to control transmission of information from the second domain to the first domain; and
generating a fourth clock enable signal to control reception of the information transmitted from the second domain to the first domain.

25. The method of claim 24, further comprising:
providing the third clock enable signal to a third logic device; and
providing the second clock signal to the third logic device.

26. The method of claim 25, further comprising:
providing the fourth clock enable signal to a fourth logic device; and
providing the first clock signal to the fourth logic device.

27. An article comprising a medium storing instructions that when executed by a processor are operable to receive a first clock signal, receive a second clock signal, generate a first clock enable signal to control transmission of information from a first domain operating at the first clock signal to a second domain operating at the second clock signal, and generate a second clock enable signal to control reception of the information transmitted from the first domain to the second domain.

28. The article of claim 27, further storing instructions that when executed by a processor, are operable to provide the first clock enable signal to a first logic device, and provide the first clock signal to the first logic device.

29. The article of claim 28, further storing instructions that when executed by a processor, are operable to provide the second enable input a second logic device, and provide the second clock signal to the second logic device.

30. The article of claim 27, further storing instructions that when executed by a processor, are operable to generate a third clock enable signal to control transmission of information from the second domain to the first domain, and generate a fourth clock enable signal to control reception of the information transmitted from the second domain to the first domain.

31. The article of claim 30, further storing instructions that when executed by a processor, are operable to provide the third clock enable signal to a third logic device, and provide the second clock signal to the third logic device.

32. The article of claim 31, further storing instructions that when executed by a processor, are operable to provide the fourth clock enable signal to a fourth logic device, and provide the first clock signal to the fourth logic device.
